(19) United States
(12) Patent Application Publication
(10) Pub. No.: US 2026/0346980 A1
(43) Pub. Date: Nov. 5, 2026

(54) HAPTIC FEEDBACK FOR AN EFFECTOR WITH MAGNETORHEOLOGICAL FLUID

(71) Applicant: Woodward, Inc., Fort Collins, CO (US)

(72) Inventor: Anel Kadiric, Mount Prospect, IL (US)

(21) Appl. No.: 19/195,779

(22) Filed: May 1, 2025

(51) Int. Cl. B64C 13/10

(52) U.S. Cl. CPC B64C 13/10

(57) ABSTRACT

Systems and methods for a mechanical input effector are provided herein. In some examples, the mechanical input effector includes one or more of a plunger coupled to the mechanical input effector, an electromagnetic coil configured to selectively generate a magnetic field, and magnetorheological fluid coupled to the plunger and configured to receive the magnetic field. In some examples, application of the magnetic field causes the magnetorheological fluid to enter into a semi-solid state, thereby restricting movement of the plunger, and correspondingly causing haptic feedback to the mechanical input effector.

### PRIORITY CLAIM/INCORPORATION BY REFERENCE

N/A

### FIELD

Certain embodiments of the disclosure relate to a multi-configuration, redundant, fixed-axis control device. More specifically, certain embodiments of the disclosure relate to a control device that includes one or more members configured to translate about one or more corresponding axes; and a mount in a fixed plane and configured to support one or more gimbals, each gimbal connected to a corresponding member and configured to translate in a corresponding axis.

### BACKGROUND

Pilot situational awareness is critical to maintain safe operation of air vehicles. In an era of increased automation, pilots must be able to transition from monitoring systems to taking control of the air vehicle safely and effectively. This can be enabled by tactile cues provided to the pilot by the controls. Methods exist to provide information to pilots that can indicate vehicle status, such as a change in flying mode from a normal mode to alternate mode, or other information regarding aircraft state.

Today's passive devices can have a fixed feel without the possibility to augment the feel dependent on vehicle status. Therefore, external methods of providing feedback to the pilot include audio messages and alerts, visual cues on displays, pulses driven by a “shaker” mechanism inside the grip, or devices connected to the axis of rotation of the inceptor to prevent or reduce motion. These can have drawbacks as they may draw the operator's attention away from the primary flight controls, provide only a singular type of feedback, or require additional components to control different axes.

Systems that have the capability to backdrive the axis of rotation, typically referred to as “active” systems, such as active side sticks, can be capable of producing a variety of cues to pilots, and even tracking and mirroring movements from one pilot station to another without a mechanical connection. But these systems can be costly to implement, carry weight penalties, and/or potentially introduce system failure modes that typically have to revert to “passive” mode.

Embodiments described herein can enable passive devices to augment their fixed feel similar to active systems, efficiently and effectively, without significant added cost or introduction of active failure modes.

Further limitations and disadvantages of conventional and traditional approaches will become apparent to one of skill in the art, through comparison of such systems with the present disclosure as set forth in the remainder of the present application with reference to the drawings.

### BRIEF SUMMARY

Embodiments of systems and/or methods are disclosed for a control device that can include one or more members configured to translate about one or more corresponding axes; and a mount in a fixed plane, and configured to support one or more gimbals, each gimbal connected to a corresponding member and configured to translate in a corresponding axis. The gimbal housings can create a cavity containing magnetorheological fluid wherein the magnetorheological fluid is configured to receive a magnetic field to reversibly change between a free liquid and semi-solid state, generating a haptic feedback.

In disclosed examples, a system includes a mechanical input effector, a plunger coupled to the mechanical input effector, an electromagnetic coil configured to selectively generate a magnetic field, and magnetorheological fluid coupled to the plunger and configured to receive the magnetic field, wherein application of the magnetic field causes the magnetorheological fluid to enter into a semi-solid state, thereby restricting movement of the plunger, and correspondingly causing haptic feedback to the mechanical input effector.

In some examples, the mechanical input effector is coupled to the plunger via a three-dimensional (3D) cam surface.

In examples, the mechanical input effector is configured to move in two degrees of freedom.

In examples, the mechanical input effector is configured to move in two degrees of freedom through two gimbals.

In examples, a first one of the two gimbals includes a cavity retaining the magnetorheological fluid.

In examples, the electromagnetic coil is positioned within the cavity.

In some examples, the system further includes a joystick connected to the mechanical input effector.

In some examples, the system further includes a processor configured to receive signals from one or more sensors configured to measure one or more external forces applied to an aircraft and to correspondingly control the magnetic field.

In examples, the processor is configured to receive signals from one or more sensors to measure one or more forces or positions applied to the mechanical input effector and to correspondingly control the magnetic field.

In examples, the mechanical input effector is included in a sidestick.

In examples, the sidestick is mounted on a side, rear, front or bottom of a control panel.

In some disclosed examples, a method for operating a control system includes: receiving, at a mechanical input effector, a force from a user; receiving, at a plunger, a force from the mechanical input effector in response to the force from the user; and applying a current to an electromagnetic coil to generate a magnetic field to adjust a state of a magnetorheological fluid from a free liquid to a semi-solid state, wherein the magnetorheological fluid is coupled to the plunger to cause haptic feedback to the mechanical input effector according to the state of the magnetorheological fluid.

In some examples, the mechanical input effector is coupled to the plunger via a three-dimensional (3D) cam surface.

In examples, the mechanical input effector is configured to move in two degrees of freedom.

In examples, the mechanical input effector is configured to move in two degrees of freedom through two gimbals.

In examples, a first one of the two gimbals includes a cavity retaining the magnetorheological fluid.

In examples, the electromagnetic coil is positioned within the cavity.

In some examples, the method further includes: receiving, at a processor, signals from one or more sensors to measure one or more external forces applied to an aircraft; and correspondingly controlling, with the processor, the magnetic field.

In some examples, the method further includes: receiving, at a processor, signals from one or more sensors to measure one or more forces or positions applied to the mechanical input effector; and correspondingly controlling, with the processor, the magnetic field.

In some examples, the method further includes a joystick connected to the mechanical input effector.

These and various other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 provides a perspective view of a control system, including a cavity containing magnetorheological fluid in accordance with an example embodiment of the disclosure.

FIGS. 2A and 2B are perspective views of a side stick configuration employing the control device shown in FIG. 1, in accordance with an example embodiment of the disclosure.

FIGS. 3 and 4 illustrate various joystick mounting options, in accordance with an example embodiment of the disclosure.

FIG. 5 illustrates a control block diagram, in accordance with an example embodiment of the disclosure.

FIG. 6 illustrates a block diagram of the components shown in FIGS. 1 and 2, in accordance with an example embodiment of the disclosure.

FIG. 7 illustrates a block diagram of the connector bank referenced in FIGS. 1 and 2, in accordance with an example embodiment of the disclosure.

FIG. 8 illustrates an example method of providing a haptic feedback, in accordance with an example embodiment of the disclosure.

The figures are not necessarily to scale. Where appropriate, similar or identical reference numbers are used to refer to similar or identical components.

### DETAILED DESCRIPTION

As utilized herein, “and/or” means any one or more of the items in the list joined by “and/or”. For example, “x and/or y” means any element of the three-element set {(x), (y), (x, y)}. Similarly, “x, y, and/or z” means any element of the seven-element set {(x), (y), (z), (x, y), (x, z), (y, z), (x, y, z)}. As utilized herein, the term “module” refers to functions that can be implemented in hardware, software, firmware, or any combination of one or more thereof. As utilized herein, the term “exemplary” means serving as a non-limiting example, instance, or illustration.

Disclosed control systems can include a single point of control (e.g., a manually operable stick) employing one or more gimbals operable to translate in one or more axes. In some examples, the control system has a fixed axis and a redundant loadpath.

Disclosed are embodiments a control system that includes one or more fixed-axis gimbals, while not sacrificing any control outputs or redundancy. Described herein are embodiments using two gimbals, but the scope of this disclosure and claims are not so-limited. The gimbals can be contained within housing(s) and enable two or more degrees of motion (e.g., one degree per gimbal) in a mechanical control effector. The mechanical control effector can couple (directly or indirectly) to a plunger (e.g., below the mechanical control effector). The gimbal housing(s) can contain one or more cavities in which magnetorheological fluid can be located. The magnetorheological fluid can transition from a free liquid or semi-solid state via exposure to a magnetic field. When the magnetorheological fluid is in the semi-solid state, it can resist movement of the plunger, creating haptic feedback response in the mechanical control effector.

Advantageously, the disclosed magnetorheological fluid configuration employed can be less complex than conventional designs. This can be achieved by utilizing, for example, a cavity filled with magnetorheological fluid. Embodiments disclosed herein can further reduce the number and cost of needed components, further reducing risk and component weight.

Embodiments of the control system can be configurable, such that the control system device can include either a passive or active control stick (e.g., manual control joystick). For example, the passive control stick can be balanced by counterweights, while an active control stick can employ sensors and/or motors to center the control stick. The sensors described herein can communicate signals that are received by a processor in the control system. The processor can correspondingly control or effect operations of the control system according to the signals it receives from the sensors.

Further, the magnetorheological fluid may be configured to receive a magnetic field corresponding to a “passive” and/or “active” response. A response, such as an active response, can provide feedback generated in relation to a force applied to an external component of the aircraft. For example, this force may correspond to a failure of one or more systems, such as aileron movement. An example of a passive response can correspond to a pilot attempting to move the control effector outside ordinarily acceptable boundaries, providing an alternate means of notification to the pilot.

The disclosed system may include position sensors along each axis of movement. These sensors may, for example, be located in the gimbal housings. The position sensors may track the position of the mechanical control input effector and transmit that position to a controller (e.g., including a proportional-integral-derivative (PID) controller). Such a controller can be incorporated in a connector bank, and can be for use in calculating a magnetic field necessary to generate a desired haptic response, as discussed further.

Moreover, the control system can be produced in a smaller size than conventional controls. As illustrated in the several figures, the joystick, gimbals, and translating members can have a vertically stacked form factor. This can keep the envelope relatively small. This can make the system more easily attachable to a variety of aircraft, with a substantial degree of mounting flexibility. Moreover, vertical symmetry can be provided (e.g., symmetry about one or more axis), and can allow for the control system to be flipped, while maintaining its functionality.

This process can further serve to reduce the number of parts to be manufactured and can reduce the time needed to train technicians to assemble the products, due to overlap between passive and active versions.

Embodiments of the disclosed system allow the system to be configurable to operate as a multi-axis lever, for example designed to move in two axes.

Instead of having magnetorheological fluid in each of a plurality of gimbals, requiring multiple applications of a magnetic field to create a feedback response across different axes of freedom, embodiments of the disclosed control system use magnetorheological fluid in a single cavity to provide feedback to the pilot control. This can reduce the number of electrical connections required to generate a haptic feedback response, and can reduce the total amount of magnetorheological fluid in the control system. This can reduce complexity and weight in the control system, and can reduce potential points of failure.

Some exemplary control systems are configured to provide control in two axes, while embodiments herein provide flexibility to accommodate a third axis of motion. In this manner, for example, the control system can control pitch, roll, and/or yaw in a single stick.

Due to the size and operability of the disclosed control system, the configurable system can have the capability to stack, for example, four levers in a throttle quadrant assembly (TQA). Further, two or more control systems can be linked together, such as to link pilot and copilot stations. As the functionality of the disclosed control system can be similar to or greater than a conventional system, the disclosed control system can be used as a replacement or substitute for conventional systems.

Commonality between one, two, and three axis inceptors advantageously can provide configurable systems, which can be modified for a specific inceptor application.

The disclosed system can provide an efficient loadpath between interface and output. This feature can allow for the system to maintain a small and effective envelope, and can yield additional cost advantages.

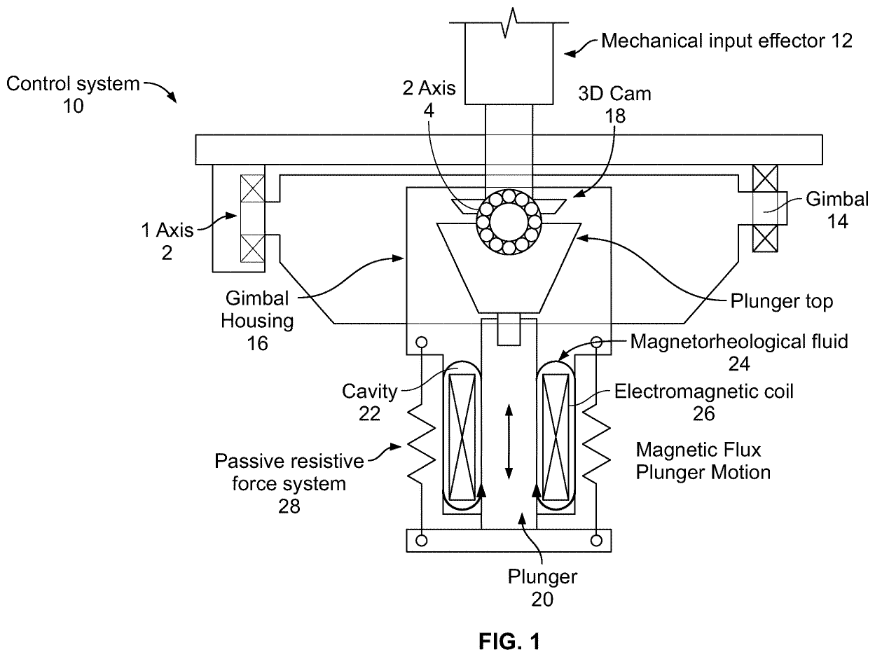

FIG. 1 is a representational cross-sectional view of a system 10, in accordance with an example embodiment of the disclosure. The mechanical input effector 12, with which the pilot engages, can be movable along multiple degrees of freedom, such as two axes 2, 4.

The mechanical input effector 12 employs one or more gimbals 14, 16 contained in housing(s) 42, for example proximate the center of the system 10, providing movement in multiple axes 2, 4 of movement. As shown, a three-dimensional cam surface 18 is aligned with a first, Y-axis 2, a second, X-axis 4, the mechanical input effector 12, and a plunger 20. The mechanical input effector 12 couples to the plunger 20 via the three-dimensional cam surface 18. The space between the plunger 20 and gimbal housing(s) 42 forms one or more cavities 22 configured to contain magnetorheological fluid 24 and one or more electromagnetic coils 26. The system 10 can further include a passive resistive force system 28 comprising a collection of biasing members (e.g. springs). The biasing members may be located between an attachment point on the gimbal 16 and the plunger 20, tensioning the biasing members. This tensioning manifests as resistive force on the mechanical input effector 12. The magnitude of plunger motion is proportional to the contour of three-dimensional cam surface 18.

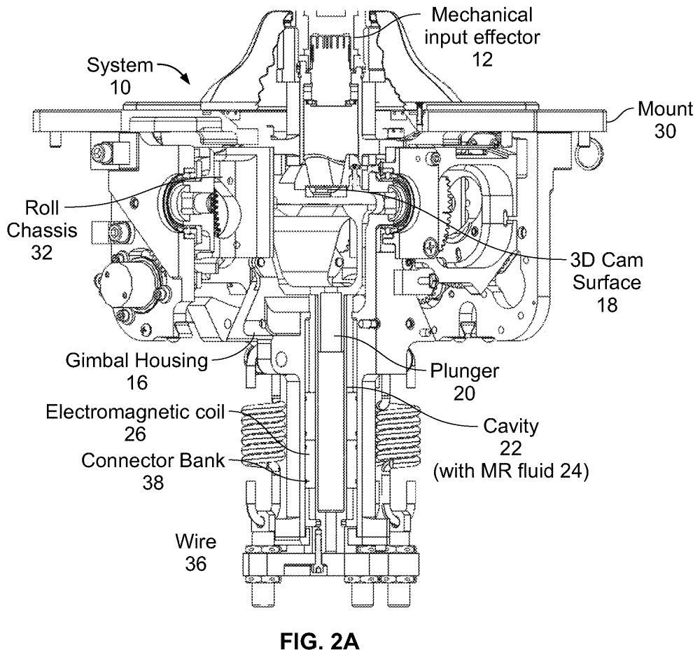

FIGS. 2A and 2B are perspective views of an embodiment of the system 10 employing the mechanical input effector 12. FIGS. 2A and 2B depict the mechanical input effector 12 coupled to gimbals 16, 32 and nested. The gimbals 16, 32 are supported by a gimbal housing 42 and supported by a mount 30.

The gimbal housing 42 may enable two degrees of movement. Embodiments may employ alternative gimbal arrangements to enable more or fewer degrees of movement. The nested gimbals 16 and 32 can be coupled to a three-dimensional cam surface 18 which enables movement in multiple degrees of freedom along axes 2, 4. The three-dimensional cam surface 18 may serve to couple the mechanical input effector 12 to a plunger 20. As shown in FIGS. 2A and 2B, the space between the plunger 20 and the gimbal housing 16 forms a cavity 22. The cavity 22 is configured to contain magnetorheological fluid 24 and optionally one or more electromagnetic coils 26. The electromagnetic coils 26 can be located outside of the cavity 22, but may still apply a sufficient magnetic field to the magnetorheological fluid 24. The electromagnetic coils 26 can be electrically connected to a connector bank 38 via a wire 36.

In some examples, such as FIG. 2B, the mechanical input effector 12 may further comprise a joystick 40 or grip assembly which may be formed for manipulation by a user. For example, the grip assembly may be sized and contoured to fit the hand of a pilot or other machine operator. Such examples enable easier operator input for the system 10 and allow the mechanical input effector 12 to be manipulated more readily.

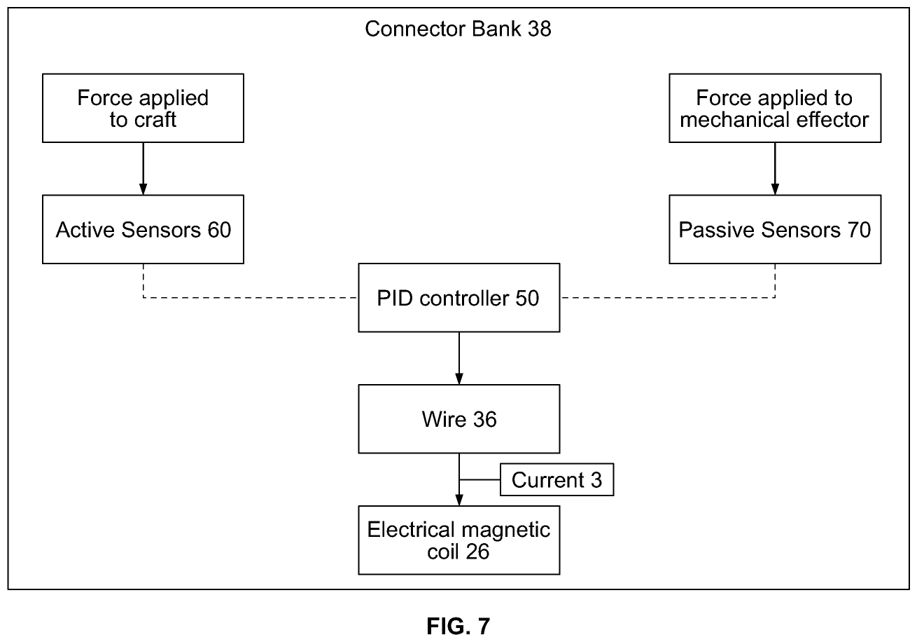

As provided in FIGS. 2A and 2B, the one or more electromagnetic coils 26 can connect to a connector bank 38 via a wire 36. An embodiment of a block diagram of the connector bank 38 is shown in FIG. 7. For example, the connector bank 38 can include a processor or controller that controls the functionality of the connector bank 38, as disclosed herein. The wire 36 can be configured to provide a current 3 from the connector bank 38 to the electromagnetic coils 26. The electromagnetic coils 26 can be configured to selectively generate a magnetic field when the current 3 is applied to the electromagnetic coils 26. When the magnetorheological fluid 24 is substantially exposed or not substantially exposed to the magnetic field from the electromagnetic coils 26, it changes between a free liquid and semi-solid state. Further, the magnetorheological fluid 24 can mechanically couple with the plunger 20. As a result, the cavity 22 can be configured such that the magnetorheological fluid 24 in the semi-solid state may restrict movement of the plunger 20. Restriction of the plunger's 20 movement can generate a feedback response in the mechanical input effector 12. This design provides the capability to operate as either an active or passive version of a side stick.

In some embodiments, the cavity 22 can be configured such that the magnetorheological fluid 24 in the semi-solid state may substantially prohibit movement of the plunger 20. In such cases, the inability to maneuver the plunger 20 can prohibit movement of the mechanical input effector 12 and any joystick 40 it may be connected with. This prohibition of movement may serve as a “lockout” mechanism to prevent operator input to the system 10 in certain situations (e.g., autopilot cruise, an emergency, other extreme conditions).

The disclosed systems provide flexibility to add, remove, and/or modify one or more components to tailor the device for a desired application. In the disclosed examples, one or more components link the joystick (e.g., joystick 40) to one or more gimbals (e.g., gimbals 16), and then to sensors, modules, etc. A control system (e.g., system 10) can include a joystick (with the gimbals) arranged within the housing. The joystick is configured to operate as a dual-axis cam plunger, which receives physical commands from a stick and force feedback via force sensor. In some examples, a spring biases the force sensor in a vertical direction. In some examples, the stick can additionally or alternatively translate upwards and/or downwards relative to the housing to provide additional commands. The stick can additionally or alternatively rotate about a central axis to provide additional commands.

The sensors can gauge movement of the joystick. Measurements from the sensors can be transmitted to a controller, which can determine movement of the stick and thus determine a commanded movement of the vehicle in which the system operates. In some examples, the system is semi-active, configured for operation without the use of a force sensor while employing the other components of an active device.

The disclosed system is capable of balancing forces acting on the joystick by using functional mass to implement an active or semi active arrangement. In some examples, a force sensor can be incorporated in the system, such that the force sensor transmits measured forces in the system 10 to a connector bank 38 to be used in calculating a current 3 to output a desired “passive” response.

The system 10 can be configured to operate as an unbalanced, passive sidestick suitable for low complexity and/or small envelope applications (e.g., smaller vehicles, such as electric vertical takeoff and landing (EVTOL) vehicles). In some examples, one or more dampers are included for each axis, to provide passive, yet unbalanced, control. These dampers may further serve as redundant passive feedback systems in case of failure of the active feedback system. In some examples, a mass balance device is attached to the stick and serves as an additional passive resistive system, adding redundance in cases where the active feedback response system of this disclosure fails. Such a design may be suitable for a variety of vehicles, including dynamic military vehicles and/or rotorcraft.

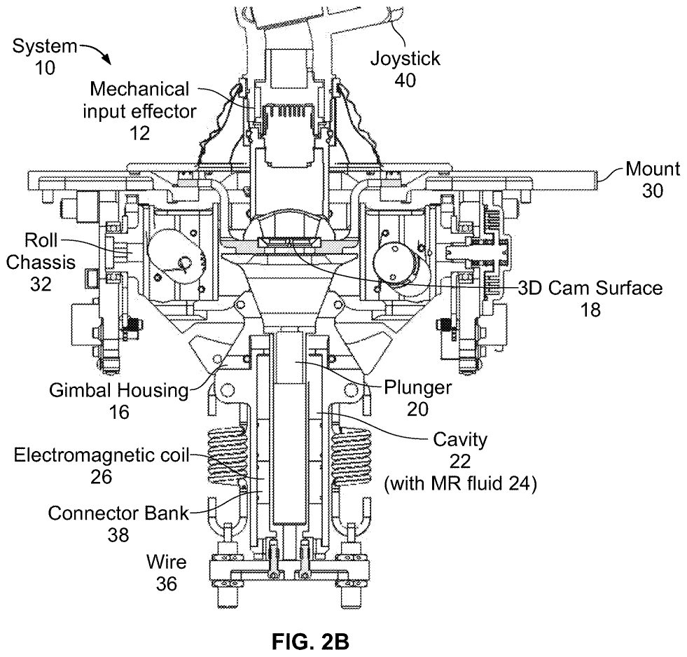

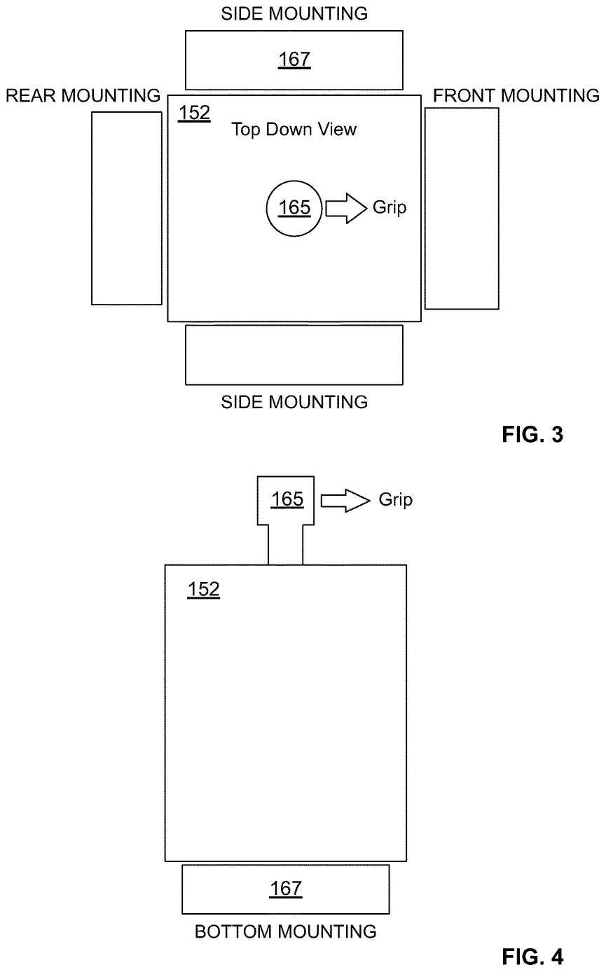

FIGS. 3 and 4 illustrate joystick mounting options, in accordance with an example embodiment of the disclosure. For instance, different types of vehicles (e.g., aerial vehicle) may benefit from employing controls mounted in different locations relative to the operator and/or other controls. For example, a helicopter typically mounts a sidestick from the base, whereas a commercial fixed winged jet mounts such a sidestick from a top plate for a passive stick, or the top plate and a second side plate of an active stick. The disclosed devices are configurable for different mounting options to accommodate a variety of control requirements.

For example, FIG. 3 shows a top-down view of a sidestick 165 (e.g., similar to the mechanical input effector 12 or joystick 40) mounted within a housing 152, with electronics and/or inceptor unit 167 mounted on any side of the housing 152 and/or sidestick 165. The configuration illustrated in FIG. 4 shows the electronics box and/or inceptor unit 167 mounted below the housing 152 and/or sidestick 165. Although illustrated as either side or bottom mounted, one or more inceptor units 167 may be mounted on two or more sides and/or the bottom.

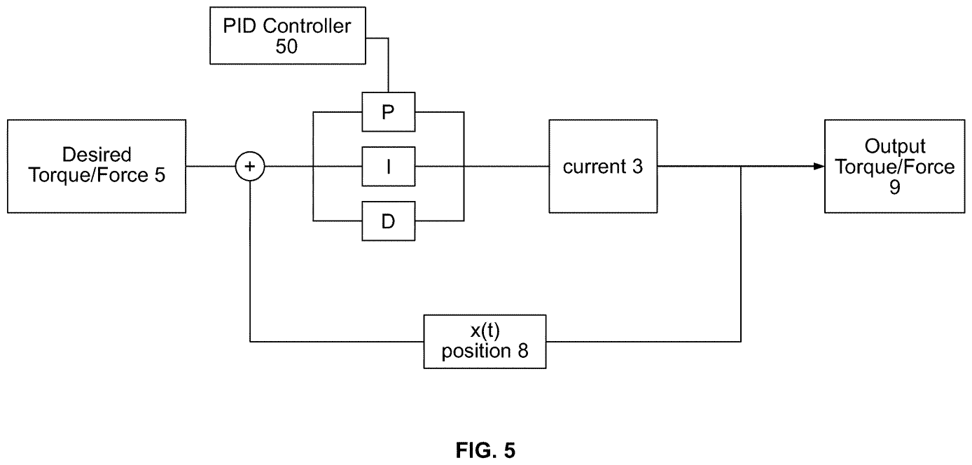

FIG. 5 illustrates a control block diagram, in accordance with an example embodiment of the disclosure. As shown, a desired torque or force 5 to be applied to the mechanical input effector 12 is calculated based on a particular position 8 of the mechanical input effector 12. The desired torque or force 5 is processed through a proportional-integral-derivative (PID) controller 50 to generate a current 3 to be applied the electromagnetic coils 26. A magnetic field is then applied by the energized electromagnetic coils 26 on the magnetorheological fluid 24. This results in the magnetorheological fluid 24 achieving a semi-solid state to output a torque or force 9 substantially close to the desired torque or force 5.

The desired torque or force 5 may correspond to either a “passive” input, based on a force applied to the mechanical input effector 12 or an “active” input, based on a force applied to an external component of the craft; for example, a wind force applied to a wing. Under each circumstance, the desired torque or force 5 is input into the PID controller 50 which generates a current 3 corresponding to the desired torque or force 5 and the particular position 8 of the mechanical input effector 12 The current 3, by way of the electromagnetic coils 26 causes the magnetorheological fluid 24 to achieve a semi-solid state, restricting movement of the plunger 20 and therefore generating an output torque or force 9 substantially equivalent to the desired torque or force 5.

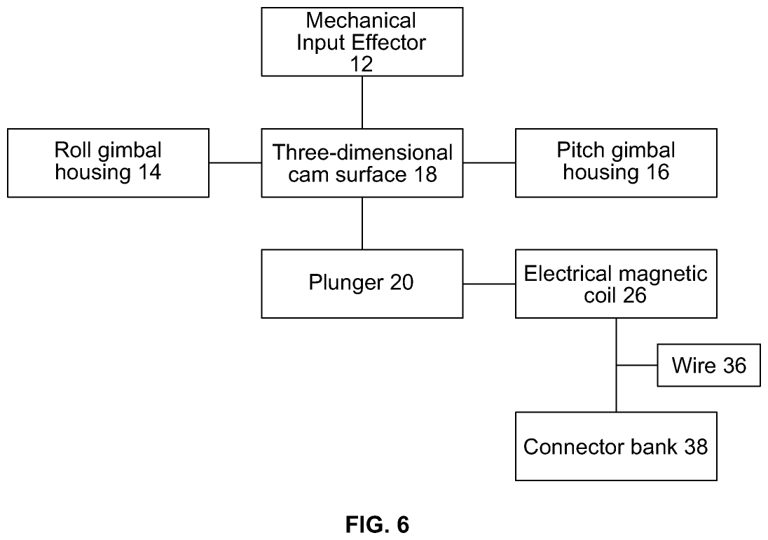

FIG. 6 illustrates a block diagram of the components shown in FIGS. 1 and 2, in accordance with an example embodiment of the disclosure. FIG. 6 provides an alternative view of the relationship between the components shown in FIGS. 1 and 2. As shown in FIG. 6, the mechanical input effector 12 can couple to one or more gimbal housings 42 via a three-dimensional cam surface 18. The three-dimensional cam surface 18 can be configured to move in each axis of movement (e.g., axes 2, 4) available to the control system 10. The three-dimensional cam surface 18 can serve as a coupling component between the mechanical input effector 12 and a plunger 20. The plunger 20 and the gimbal housings 42 can form a cavity 22 which is configured to contain magnetorheological fluid 24 and optionally one or more electromagnetic coils 26. The electromagnetic coils 26 can be connected to a connector bank 38 via a wire 36.

FIG. 7 illustrates a block diagram of the connector bank 38 referenced in FIGS. 1, 2A, 2B, and 6 in accordance with an example embodiment of the disclosure. FIG. 7 illustrates that the connector bank 38 may comprise the PID controller 50 shown in FIG. 5. As shown in FIG. 7, the connector bank 38 can be electrically connected to sensors measuring external and internal forces on the system 10. The external forces may, for example, include forces applied to a wing or engine of a plane. The internal forces may, for example, include forces applied to the mechanical input effector 12 by an operator. External forces can be measured by so-called “active sensors” 60 and may be used as inputs to generate a current as shown in FIG. 5. These active sensors 60 may include one or more force or torque sensors located externally on the craft. Internal forces can be measured by so-called “passive sensors” 70 and may similarly be used as inputs to generate a current as shown in FIG. 5. These passive sensors 60 may include one or more force, torque, or position sensors located within the system 10. The connector bank 38 is configured to calculate the current corresponding to the desired output torque or force and output the current 3 to the electromagnetic coil 26 via a wire 36.

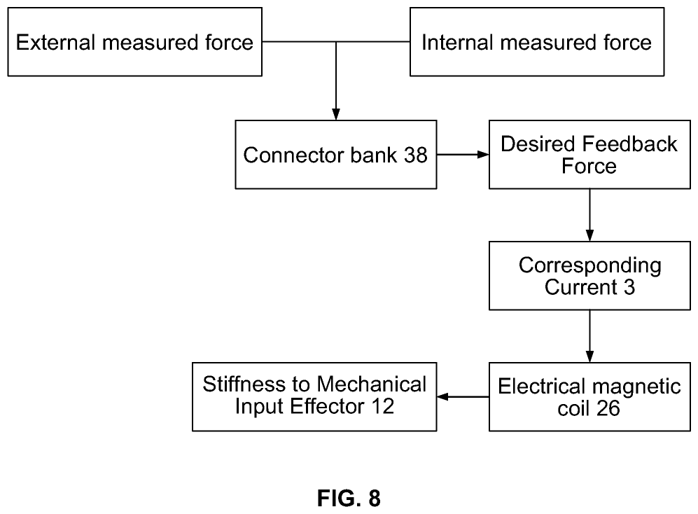

FIG. 8 illustrates a flowchart of the method of providing a haptic feedback, in accordance with an example embodiment of the disclosure. FIG. 8 presents the method of generating a haptic feedback with reference to individual components. As shown in FIG. 8, an external force measurement corresponding to a force on the aircraft or an internal force measurement corresponding to a force on the mechanical input effector 12 may be input into a connector bank 38. The connector bank 38 then uses the force measurement input alongside a current position of a mechanical input effector 12 to generate a desired output torque or force. The desired output torque or force is then used to generate a current 3 by a PID controller in the connector bank 38. The current 3 is then run through one or more electromagnetic coils 26 via a wire 36 connected to the connector bank 38. A magnetic field is then generated by the electromagnetic coils 26. Exposure to the magnetic field causes the magnetorheological fluid 24 to reversibly change from a free liquid to a semi-solid state, restricting movement of the plunger 20. The restriction of movement of the plunger 20 causes a corresponding stiffness in the mechanical input effector 12, corresponding to a haptic feedback response in the mechanical input effector 12.

In disclosed examples, the cavity 22 may be further configured to contain sufficient magnetorheological fluid 24 to completely prohibit movement of the plunger 20 when the magnetorheological fluid 24 is in the semi-solid state. In such cases, the restriction of movement of the plunger 20 will serve to halt movement of the three-dimensional cam surface 18, thereby prohibiting movement of the mechanical input effector 12. When the mechanical input effector 12 is prohibited from moving, it serves to “lock” the control input system, prohibiting an operator from taking further action. Such example use cases may provide safety layers over preexisting solutions. Traditional systems “locking” operator input require solenoids or other heavier devices, however, this example has the advantage of being integrated into a haptic feedback device, reducing complexity and weight of the control system.

In disclosed examples, the joystick is applicable in a sidestick application to sense pilot commands corresponding to a desired yaw, angle of pitch and/or roll axes of an aircraft. For example, in an aircraft cockpit environment, a sidestick or sidestick controller is an aircraft control column (or joystick) that is located on the side console of the pilot. For instance, only one hand is required to operate the sidestick, which makes it a simple and intuitive tool to control yaw, pitch and/or roll of an aircraft. Although examples are provided with respect to a sidestick application, aircraft controls mounted in control columns may be arranged in a center of the cockpit. Moreover, applications beyond aerospace, and beyond control mechanisms, are considered as well.

Further, although examples are provided with respect to applications in a flight deck (e.g., a sidestick application), the technology and platform may be useful in a variety of applications in aerospace, manufacturing, automotive, electronic sports, virtual gaming, or transportation, to list but a few. In examples, the disclosed control technology can be employed in joystick applications, such as large industrial equipment (e.g., construction, agriculture, etc.), gaming, or other applications that employ a single, physical control interface for multiple axis control.

Advantageously, the control system employs redundant channels, designed to meet or exceed regulatory guidelines for redundancy in a sidestick application.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A system, comprising:
a mechanical input effector;
a plunger coupled to the mechanical input effector;
an electromagnetic coil configured to selectively generate a magnetic field; and
a magnetorheological fluid coupled to the plunger and configured to receive the magnetic field,
wherein application of the magnetic field causes the magnetorheological fluid to enter into a semi-solid state, thereby restricting movement of the plunger, and correspondingly causing haptic feedback to the mechanical input effector.

2. The system of claim 1, wherein the mechanical input effector is coupled to the plunger via a three-dimensional (3D) cam surface.

3. The system of claim 1, wherein the mechanical input effector is configured to move in two degrees of freedom.

4. The system of claim 3, wherein the mechanical input effector is configured to move in two degrees of freedom through two gimbals.

5. The system of claim 4, wherein a first one of the two gimbals includes a cavity retaining the magnetorheological fluid.

6. The system of claim 5, wherein the electromagnetic coil is positioned within the cavity.

7. The system of claim 1, further comprising a joystick connected to the mechanical input effector.

8. The system of claim 1, further including a processor configured to receive signals from one or more sensors configured to measure one or more external forces applied to an aircraft and to correspondingly control the magnetic field.

9. The system of claim 8, wherein the processor is configured to receive signals from one or more sensors to measure one or more forces or positions applied to the mechanical input effector and to correspondingly control the magnetic field.

10. The system claim 1, wherein the mechanical input effector is included in a sidestick.

11. The system of claim 10, wherein the sidestick is mounted on a side, rear, front or bottom of a control panel.

12. A method for operating a control system, comprising:
receiving, at a mechanical input effector, a force from a user;
receiving, at a plunger, a force from the mechanical input effector in response to the force from the user; and
applying a current to an electromagnetic coil to generate a magnetic field to adjust a state of a magnetorheological fluid from a free liquid to a semi-solid state,
wherein the magnetorheological fluid is coupled to the plunger to cause haptic feedback to the mechanical input effector according to the state of the magnetorheological fluid.

13. The method of claim 12, wherein the mechanical input effector is coupled to the plunger via a three-dimensional (3D) cam surface.

14. The method of claim 12, wherein the mechanical input effector is configured to move in two degrees of freedom.

15. The method of claim 14, wherein the mechanical input effector is configured to move in two degrees of freedom through two gimbals.

16. The method of claim 15, wherein a first one of the two gimbals includes a cavity retaining the magnetorheological fluid.

17. The method of claim 16, wherein the electromagnetic coil is positioned within the cavity.

18. The method of claim 12, further including:
receiving, at a processor, signals from one or more sensors to measure one or more external forces applied to an aircraft; and
correspondingly controlling, with the processor, the magnetic field.

19. The method of claim 12, receiving, at a processor, signals from one or more sensors to measure one or more forces or positions applied to the mechanical input effector; and
correspondingly controlling, with the processor, the magnetic field.

20. The method of claim 12, further comprising a joystick connected to the mechanical input effector.
